(19) United States
(12) Patent Application Publication
(10) Pub. No.: US 2016/0226817 A1
(43) Pub. Date: Aug. 4, 2016

(54) APPARATUS AND METHOD FOR CREATING BLOCK-TYPE STRUCTURE USING SKETCH-BASED USER INTERACTION

(71) Applicant: ELECTRONICS AND TELECOMMUNICATIONS RESEARCH INSTITUTE, Daejeon (KR)

(72) Inventors: Sae Hoon KANG, Daejeon (KR); Ji Soo SHIN, Daejeon (KR); Sun Hee YANG, Daejeon (KR)

(21) Appl. No.: 14/993,273

(22) Filed: Jan. 12, 2016

(30) Foreign Application Priority Data
Feb. 3, 2015 (KR) 10-2015-0016978

(51) Int. Cl. H04L 29/12; H04L 12/741

(52) U.S. Cl. CPC H04L 61/103; H04L 45/745

(57) ABSTRACT

An apparatus and method for resolving a mapping between an address of a physical or virtual node and a physical address on a network, in the SDN in which a network is controlled based on software by a centralized controller. The apparatus may include an address matcher and a controller. The controller may determine all matters related to packet forwarding in a centralized method; and an application for performing desired functions is programmed in the controller, which is then installed therein. Accordingly, the purpose thereof is to provide new network services easily.

### CROSS-REFERENCE TO RELATED APPLICATIONS

This application claims the benefit under 35 U.S.C. §119(a) of Korean Patent Application No 10-2015-0016978, filed on Feb. 3, 2015, in the Korean Intellectual Property Office, the entire disclosure of which is incorporated herein by reference for all purposes.

### BACKGROUND

1. Field

The following description relates to a system and method for resolving an address based on a software-defined network (SDN), and more particularly, to an apparatus and method for determining a mapping between an address of a physical or virtual node and a physical address on a network, in the SDN in which a network is controlled based on software by a centralized controller.

2. Description of the Related Art

When data is transferred between hosts in an IP network, an IP address is used at a level of communications software of each terminal. However, when actual data is transferred, a physical address is used to transfer data.

To transfer data using a physical address, an address resolution protocol (ARP) is used in relating an IP address and a physical address. In the ARP, to transfer data between each of the hosts, a host to transmit the data is required to have information on a physical address of a host to receive the data, such as a media access control (MAC) address.

Thus, the transmission host may use a method for, in an overall network, broadcasting an ARP request packet for requesting a physical address corresponding to the IP address of the reception host, by using the physical address, e.g., a MAC address.

However, such a method may cause problems in lowering a network efficiency owing to frequent ARP broadcasting for communications between virtual machines in a large-scale virtual data environment, in which a lot of virtual machines exist. Moreover, in a case where virtual machine (VM) migration occurs, which reassigns a virtual machine to another physical server depending on the need, a virtual subnet may exist overall in a network, so that an ARP traffic may be accordingly spread overall in the network.

### SUMMARY

The present disclosure may perform a simple packet transmission function only according to a command of a controller in a transmission plane, determine all matters related to packet forwarding in a centralized method by the controller, and prevent problems in lowering a network efficiency, thereby easily providing network services.

In one general aspect, an apparatus for resolving a physical address based on SDN includes: an address matcher to receive an address resolution protocol (ARP) request packet, and match a flow entry included in a flow table corresponding to the ARP request packet, wherein the address matcher may in response to the flow entry and the ARP request packet being matched, generate a packet-handling rule and reply with a ARP reply packet, and in response to the flow entry and the ARP request packet being not matched, encapsulate the ARP request packet and transmit the encapsulated ARP request packet, and a controller to update a packet-handling rule by matching information on virtual and physical addresses to information included in an ARP table, wherein the information on virtual and physical addresses is acquired through the received encapsulated ARP request packet and a packet-in message.

The address matcher may further include: a flow table scanner to receive the ARP request packet and match the ARP request packet to the flow entry that is included in the flow table, and a packet-handling rule generator to, in response to the matched flow entry being scanned by the flow table scanner, generate the packet-handling rule through the information included in the flow entry, convert the received ARP request packet to the ARP reply packet that includes physical address information of a communications terminal, i.e. a designated receiver, and reply with the ARP reply packet to the ARP request packet; and in response to the matched flow entry being not scanned, encapsulate the received ARP request packet and transmit the encapsulated ARP request packet including the packet-in message to the controller.

The packet-handling rule generator may in response to a reception of a new packet-handling rule from the controller, update the packet-handling rule, existing in the packet-handling generator, to the newly received packet-handling rule and handle packets.

The controller may further include: a physical address matcher to match information on virtual and physical addresses, which are acquired through the received encapsulated ARP request packet and the packet-in message, to the ARP table that includes relation information between the virtual and physical addresses collected from each user communications terminal connected to an SDN environment; and a packet-handling rule updater to acquire a physical address of a communications terminal, i.e., the designated receiver, to forward a packet from the ARP table, generate a packet-handling rule for forwarding the packet to the physical address, transmit the generated packet-handling rule to an address matcher, and update the pre-existing packet-handling rule.

The packet-handling rule updater may collect the relation information between information on the virtual and physical addresses according to a predetermined period of time set by a user, so as to generate the ARP table that includes the relation information between the virtual and physical addresses from each user communications terminal connected to an SDN environment.

The packet-handling rule updater may according to the packet-handling rule, convert the encapsulated ARP request packet to the ARP reply packet that includes the address information of the communications terminal, i.e., the designated receiver, and reply with the ARP reply packet to the communications terminal that has transmitted the ARP request packet.

In another general aspect, a method of resolving a physical address based on SDN includes: receiving an address resolution protocol (ARP) request packet, and matching a flow entry included in a flow table corresponding to the ARP request packet, wherein the matching comprises, in response to the flow entry and the ARP request packet being matched, generating a packet-handling rule and reply with a ARP reply packet, and in response to the flow entry and the ARP request packet being not matched, encapsulating the ARP request packet and transmitting the encapsulated ARP request packet; and updating a packet-handling rule by matching information on virtual and physical addresses to information included in an ARP table, wherein the information on virtual and physical addresses is acquired through the received encapsulated ARP request packet and a packet-in message.

The encapsulating of the ARP request packet and the transmitting of the encapsulated ARP request packet may include receiving the ARP request packet and matching the ARP request packet to the flow entry that is included in the flow table, and in response to the matched flow entry being scanned, generating the packet-handling rule through the information included in the flow entry, converting the received ARP request packet to the ARP reply packet that includes physical address information of a communications terminal, i.e. a designated receiver, and replying with the ARP reply packet to the ARP request packet; and in response to the matched flow entry being not scanned, encapsulating the received ARP request packet and transmitting the encapsulated ARP request packet including the packet-in message.

The transmitting of the encapsulated ARP request packet including the packet-in message may include, in response to a reception of a new packet-handling rule, updating the pre-existing packet-handling rule to the newly received packet-handling rule and handling packets.

The updating of the packet-handling rule may include: matching information on virtual and physical addresses, which are acquired through the received encapsulated ARP request packet and the packet-in message, to the ARP table that includes relation information between the virtual and physical addresses collected from each user communications terminal connected to an SDN environment; and acquiring a physical address of a communications terminal, i.e., the designated receiver, to forward a packet from the ARP table, generating a packet-handling rule for forwarding the packet to the physical address, transmitting the generated packet-handling rule, and updating the pre-existing packet-handling rule.

The updating of the packet-handling rule may include: collecting relation information between information on the virtual and physical addresses according to a predetermined period of time set by a user, so as to generate the ARP table that includes the relation information between the virtual and physical addresses from each user communications terminal connected to an SDN environment.

The updating of the packet-handling rule may include: according to the packet-handling rule, converting the encapsulated ARP request packet to the ARP reply packet that includes the address information of a communications terminal, i.e., the designated receiver, and replying with the ARP reply packet to the communications terminal that has transmitted the ARP request packet.

Other features and aspects may be apparent from the following detailed description, the drawings, and the claims.

### BRIEF DESCRIPTION OF THE DRAWINGS

FIG. 1 is a diagram illustrating address resolution protocol (ARP) packets according to an exemplary embodiment.

FIG. 2 is a diagram illustrating an apparatus 1000 for resolving a physical address based on SDN according to an exemplary embodiment

FIG. 3 is a detailed diagram illustrating an address matcher of FIG. 2.

FIG. 4 is a specific diagram illustrating a controller of FIG. 2.

FIG. 5 is a flowchart illustrating a method of resolving a physical address based on SDN according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Similar reference numerals are used to refer to similar elements, features, and structures throughout the drawings and the detailed description. The description that one portion ‘comprises’ one element does not indicate that other elements are excluded, but it indicates other elements are further included if there are not the descriptions against the present disclosure.

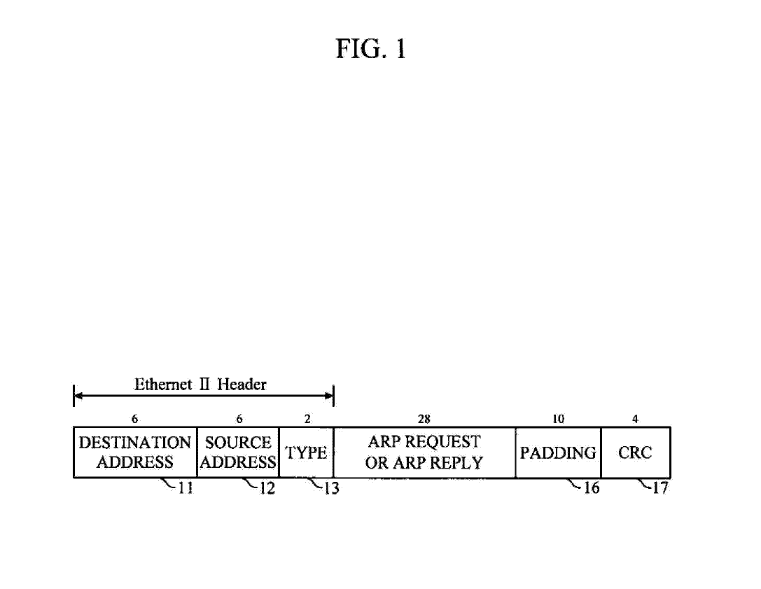

Hereinafter, an apparatus and method for resolving a physical address based on a software-defined network (SDN) will be described according to an exemplary embodiment, referring to FIGS. 1 to 5.

FIG. 1 is a diagram illustrating an address resolution protocol (ARP) packet according to an exemplary embodiment.

Referring to FIG. 1, an ARP packet 10 transmitted in an SDN environment may include the following fields: a destination address 11, a source address 12, a type 13, an ARP request 14 or an ARP reply 15, a padding 16, and a cyclic redundancy check (CRC) 17.

The destination address 11 may be used for, in a data transmission, identifying a receiver or a receiving station, which receives the data. The destination address 11 may be mainly used in a data transmission of a packet type that needs to clearly designate a transmitting station and a receiving station.

For example, the destination address 11 may be 6-byte and use media access control (MAC) addresses of a receiver and a receiving station.

The source address 12 may refer to an address of a device, i.e. a source from which the data is transmitted, or an address of a memory location.

For example, the source address 12 may be 6 byte and use MAC addresses of a transmitter and a transmitting station.

The type 13 may refer to a type for showing a type of an upper layer protocol, and if the type is greater than or equal to 0x600 and less than or equal to DIX 2.0, may be interpreted to be length (802.3).

Here, the type field 13 may have a lot of types, a typical type of which is the internet protocol (IP).

For example, the type field 13 may be 2-byte.

The padding 16 may refer to a fixed length, which is acquired by adding a symbol having no space or meaning to the last of a record or block. This technique may be used in a case where a fixed-length record or a fixed-block, and also used in processing short data.

For example, the padding 16 may be 10-byte.

The CRC 17 is one of the methods for detecting an error when data is transmitted. If the CRC 17 transmits an error checking field, i.e., a frame check sequence (FCS), along with a result, which has been acquired through a polynomial from data of a transmission side, a reception side may perform an error check using the same method as the above-mentioned method.

For example, the CRC may be 4-byte. If the CRC calculation is wrong, the reception side sends a negative acknowledgement (NAK) signal or a re-transmission request to the transmission side until the CRC calculation is correct. The CRC 17 is used in a tape backup device or other devices using continuous communications.

In a case where a transmitter has no information on a physical address of a receiver, the ARP request 14 requests the information for collecting information on the address and resolving the address of the receiver.

In general, the ARP request 14 requests the information by using a method for storing, in a packet, and broadcasting an instruction for requesting the information on the physical address of the receiver.

Here, the broadcasting method refers to a communication method, in which one transmitting terminal designates several receiving terminals and transmits the same contents to the several receiving terminals at the same time.

The ARP reply 15 reply with the information on the physical address of the receiver to the transmitter, in response to the above-mentioned ARP request 14.

In general, the ARP reply 15 replies using a method for storing, in a packet, the information on the physical address of the receiver and transmitting the information to the physical address of the transmitter, which has transmitted the ARP request packet.

According to such exemplary embodiments, data may be transferred between hosts in a network by using a virtual address at a level of communications software of each terminal, but actual data may be transferred in a network by using a physical address.

Here, the physical address may be in general a 48-bit Ethernet MAC address that a network interface card has, but may be another type of address according to a link layer.

Also, as the virtual address, an IP address is usually used, but another address at a software level may be also used.

According to an exemplary embodiment using a MAC address as a physical address and using an IP address as a virtual address, the host A can transmit data to the host B only when knowing a MAC address of the host B. Thus, in a case in which the host A has no information on the MAC address of the host B, the host A may broadcast, to a communications terminal connected to an overall network, an ARP request packet for requesting information on the MAC address corresponding to an IP address of the host B, by using the MAC address (FFFFFFFFFFFF).

Here, the host 13 receiving the ARP request packet may send notification of its own MAC address to the host A through an ARP reply packet.

According to such an exemplary embodiment using the ARP to match each physical address of the communications terminal for network communications, the ARP request and reply packets may be used.

Here, the ARP request packet may include a physical address of a transmitter, such as a MAC address, an IP address, and an IP address of a destination, but the MAC address of the destination may be filled with only “0”s according to an exemplary embodiment.

Here, the ARP refers to a protocol used for relating the IP address to the physical address.

Referring to FIG. 1, since the ARP request and reply packets are configured in the same field, the ARP request and reply packets may be simply changed by using an action of changing a field value, such as a flow-mod message (instruction) of OpenFlow.

As described above, it is possible for the ARP request packet to be simply replaced by the ARP reply packet. Thus, after the ARP reply packet is changed according to information stored in matched flow entries of a flow table, the ARP request packet received without being broadcast may be transmitted.

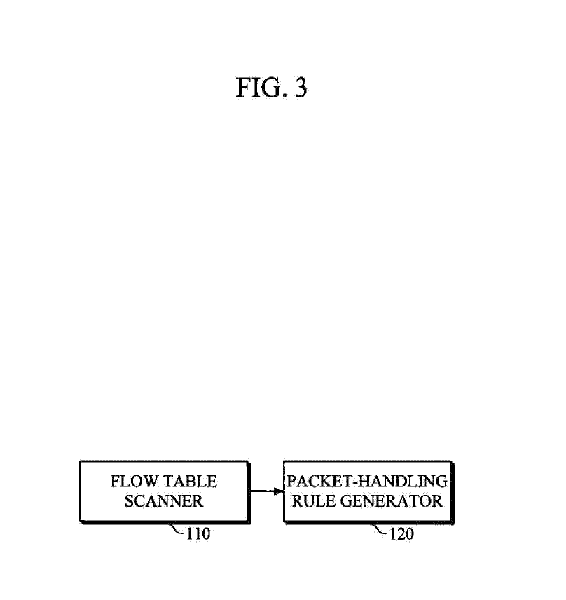

Such a matching method may be specifically described later referring to FIG. 3.

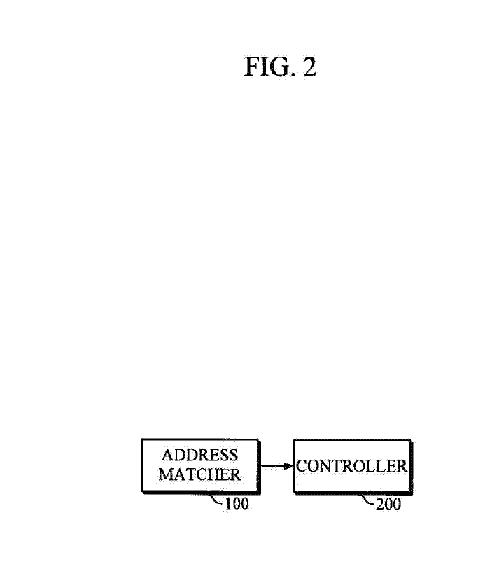

FIG. 2 is a diagram illustrating an apparatus 1000 for resolving a physical address based on SDN according to an exemplary embodiment.

Referring to FIG. 2, the apparatus 1000 may include an address matcher 100 and a controller 200.

The address matcher 100 receives the ARP request packet and matches the flow entry included in the flow table corresponding to the ARP request packet. If the flow entry is matched to the ARP request packet, the address matcher 100 may generate a packet-handling rule and reply with an ARP reply packet; and if not matched, the address matcher 100 may encapsulate the ARP request packet and transmit the encapsulated ARP request packet.

The matching method to the flow entry may be specifically described later referring to FIG. 3.

If the address matcher 100 succeeds in matching the ARP request packet to the flow entry, the address matcher 100 may generate a packet handling rule through information included in the matched flow entry, and accordingly forward a packet. If not matched, the address matcher 100 may transmit a packet-in message to the controller 200, thereby receiving an updated packet handling rule to accordingly transmit a packet.

Here, the encapsulation refers to transmitting communications protocol information of an upper layer in communications, which is included in a user information region of a lower-layer communications protocol frame.

Encapsulated information may be transmitted by a network device, and as opposed to encapsulation, decapsulation is performed in a destination, which refers to the process of unwrapping what has been encapsulated. Such an operation may enable data communications while a mutual standard protocol is obeyed even between heterogeneous devices.

According to an exemplary embodiment using the transfer control protocol/internet protocol (TCP/IP), upper-layer data and header information may be encapsulated in protocol information of a lower layer.

The controller 200 may update a packet-handling rule by matching information on the virtual and physical addresses to information included in the ARP table, wherein the information on the virtual and physical addresses is acquired through the received encapsulated ARP request packet and the packet-in message.

In addition, the controller 200 may store the updated packet-handling rule in the ARP table, and set a proper timeout value in each entry of the ARP table.

FIG. 3 is a detailed diagram illustrating an address matcher of FIG. 2.

Referring to FIG. 3, a packet handler may include a flow table scanner 110 and a packet-handling rule generator 120.

The flow table scanner 110 may receive the ARP request packet and then match the ARP request packet to the flow entry that is included in the flow table.

Here, the flow table represents asynchronous sequential circuits and gives information of the next state based on a current state and input.

The flow table may refer to a set of the flow entries that include information for packet-handling.

Also the flow entry may refer to the information of each item included in the flow table, and include information for predicting the next operation or a state change corresponding to an input value.

Here, according to an exemplary embodiment, the method for matching the ARP request packet to the flow entry of the flow table may refers to the following operations: acquiring virtual-physical address information from the received ARP request packet, checking whether the address information corresponding to the acquired information exists in the flow entry of the flow table included in the flow table scanner 110, and in response to the existence of the address information, matching the address information to the relevant flow entry.

The flow entry may include a packet-handling rule for forwarding the received packet and an action field that describes how to handle the packet.

Here, the action regarding the packet may include: a packet drop; a transmission to a specific port; a change of a packet header; an insertion or removal of a specific tag, and the like. Also, the action may include a counter field for managing statistical information of the flow.

In a case where the flow entry to be matched by the flow table scanner 110 is scanned, the packet-handling rule generator 120 may generate the packet-handling rule through the information included in the flow entry, convert the received ARP request packet to the ARP reply packet that includes the physical address information of the communications terminal, i.e. the designated receiver, and reply with the ARP reply packet to the ARP request packet. In a case where the flow entry to be matched is not scanned, the packet-handling rule generator 120 may encapsulate the received ARP request packet and transmit the encapsulated ARP request packet including the packet-in message to the controller 200.

The packet-handling rule refers to a rule regarding where or how to forward the received packet.

The method for generating the packet-handling rule may include the following operations: matching the ARP request packet to the flow table stored in the flow table scanner 110; checking whether there is a flow entry to be matched to the ARP request packet; and in response to the existence of the flow entry to be matched, generating a rule for forwarding the corresponding packet according to action information of the corresponding flow entry, and handling the subsequent packets according to the forwarding rule. However, examples of the generation method are not limited thereto.

The packet-in message refers to message information included in a packet. In a case where the flow entry to be matched is not scanned, the packet-in message may include a request for updating a packet-handling rule to handle the packet that the corresponding communications terminal transmits.

When receiving a new packet-handling rule from the controller 200, the packet-handling generator 120 updates the pre-existing packet-handling rule to the newly received packet-handling rule, and handles the packet.

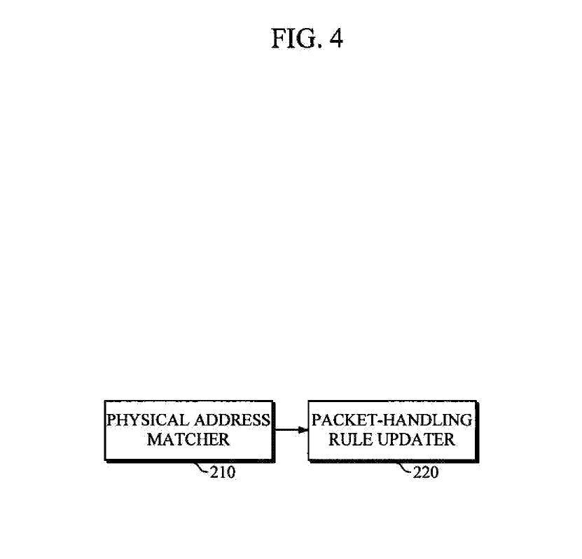

FIG. 4 is a specific diagram illustrating a controller of FIG. 2.

Referring to FIG. 4, a controller 200 may include a physical address matcher 210 and a packet-handling rule updater 220.

The physical address matcher 210 may match information on virtual and physical addresses, which are acquired through a received encapsulated ARP request packet and a packet-in message, to an ARP table that includes the relation information between the virtual and physical addresses collected from each user communications terminal connected to an SDN environment.

Here, the ARP table may refer to what is stored in a flow table format by collecting the virtual and physical addresses of all the communications terminals connected to the SDN environment. The ARP table may include the information on the virtual and physical addresses corresponding to each communications terminal, thereby matching the communications terminal's virtual address to be transmitted to the communications terminal's physical address to be received, which is then acquired.

The ARP table may be generated by collecting the virtual and physical addresses of all the communications terminals, connected to the SDN environment, according to a predetermined period of time set by a user. However, examples of the ARP table are not limited thereto, and only what is generated by collecting information may be used without limit, wherein the information may include the broadcasting to request the information on the virtual and physical addresses to the communications terminals when the packet-in message is received.

The packet-handling rule updater 220 may generate a packet-handling rule for forwarding a packet to a physical address by acquiring the physical address of a communications terminal, i.e., the designated receiver, to forward the packet from the ARP table, transmit the generated packet-handling rule to an address matcher 100, and update the pre-existing packet-handling rule.

Also, the packet-handling rule updater 220 may, according to the packet-handling rule, convert the encapsulated ARP request packet to the ARP reply packet that includes the address information of the communications terminal, i.e. the designated receiver, and reply with the ARP reply packet to the communications terminal that has transmitted the ARP request packet.

To generate the ARP table from each user communications terminal connected to the SDN environment, the relation information between the virtual and physical addresses may be collected from each user communications terminal according to a predetermined period of time set by a user, wherein the ARP table includes the information therebetween. However, examples of such a collection method are not limited thereto, and only what collects information to generate such an ARP table may be used without limit.

The packet-handling rule updater 220 may generate a packet-handling rule for forwarding a packet to a physical address by acquiring the physical address to forward a packet from the ARP table, transmit the generated packet-handling rule to be applied to the packet-handling in an address matcher 100, and update the pre-existing packet-handling rule.

Here, the update refers to overwriting the pre-existing packet-handling rule and the pre-existing flow entry of the flow table by transmitting the newly generated packet-handling rule to the address matcher 100. However, examples of the updating method is not limited thereto, and only what changes the pre-existing packet-handling rule to the newly generated packet-handling rule may be used without limit.

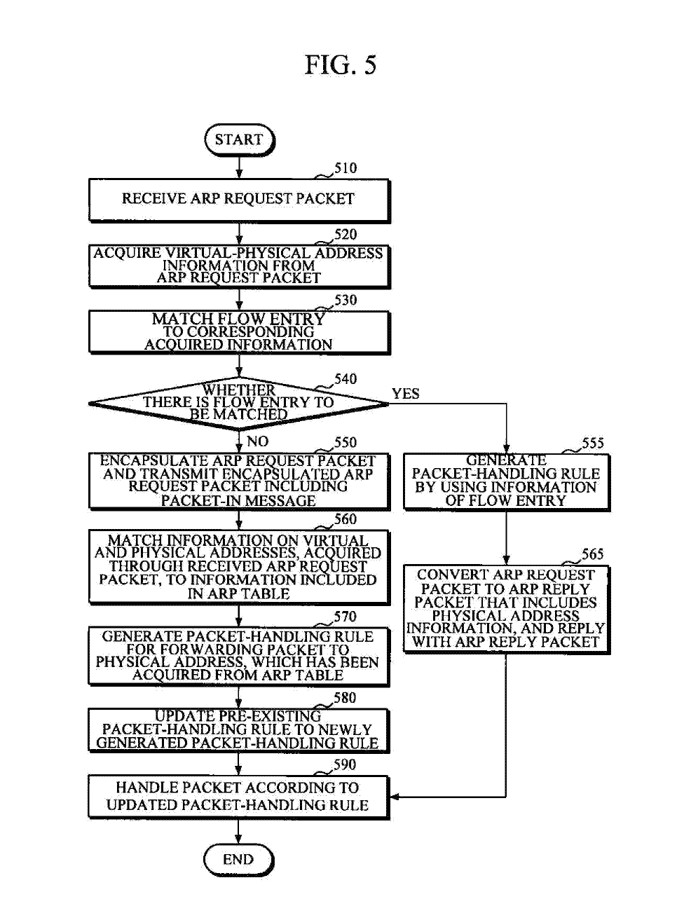

FIG. 5 is a flowchart illustrating a method of resolving a physical address based on SDN according to an exemplary embodiment.

The method includes receiving a broadcast ARP request packet in 510, acquiring information on virtual and physical addresses from the received ARP request packet in 520, and matching a flow entry included in a flow table corresponding to the information on the virtual and physical addresses in 530.

Here, the flow table represents asynchronous sequential circuits and gives information of the next state based on a current state and input.

According to an exemplary embodiment, the flow table may refer to a set of the flow entries that include information for packet-handling of each flow.

Also, the flow entry may refer to the information of each item included in the flow table, and include information for predicting the next operation or a state change corresponding to an input value.

The flow entry may include a packet-handling rule for forwarding the received packet and an action field that describes how to handle the packet.

Here, the action regarding the packet may include: a packet drop; a transmission to a specific port; a change of a packet header, an insertion or removal of a specific tag, and the like. Also, the action may include a counter field for managing statistical information of the flow.

The method may include: checking whether there is a flow entry to be matched to address information of an ARP request packet in 540; in response to the existence of the flow entry to be matched to the ARP request packet, generating a packet-handling rule by using information included in the flow entry in 555; and converting the received ARP request packet to the ARP reply packet that includes the physical address information, thereby replying to the request in 565.

The method for generating the packet-handling rule may include the following operations: matching the address information, included in the ARP request packet, to the flow table; checking whether there is a flow entry to be matched to the ARP request packet; and in response to the existence of the flow entry to be matched, generating a rule for forwarding the corresponding packet according to action information of the corresponding flow entry, and handling the subsequent packets according to the forwarding rule. However, examples of the generation method are not limited thereto.

Here, matching the address information, included in the ARP request packet, to the flow table refers to matching the address information to the information on the corresponding communications terminal, included in the flow entry of the flow table, so as to acquire information on the physical address of the communications terminal, i.e., the receiver, by using the communications terminal's virtual or physical address, which is included in the ARP request packet and is to be transmitted.

On the contrary, the method may include, in a case where the flow entry to be matched is not scanned, encapsulating the ARP request packet, which has been received to update the packet-handling rule and resolve the physical address information, and transmitting a packet-in message to a controller 200 in 550.

The packet-in message refers to message information included in a packet. In a case where the flow entry to be matched is not scanned, the packet-in message may include a request for updating a packet-handling rule to handle the packet that the corresponding communications terminal transmits.

The method may include operation 560 of matching information on virtual and physical addresses, which are acquired through a received encapsulated ARP request packet and a packet-in message, to an ARP table that includes the relation information between the virtual and physical addresses collected from each user communications terminal connected to an SDN environment.

Here, the ARP table may refer to what is stored in a flow table format by collecting the virtual and physical addresses of all the communications terminals connected to the SDN environment. The ARP table may include the information on the virtual and physical addresses corresponding to each communications terminal, thereby matching the communications terminal's virtual address to be transmitted to the communications terminal's physical address to be received, which is then acquired.

The ARP table may be generated by collecting the virtual and physical addresses of all the communications terminals, connected to the SDN environment, according to a predetermined period of time set by a user. However, examples of the ARP table are not limited thereto, and only a method for collecting information may be used without limit, wherein the information may include the broadcasting to request the information on the virtual and physical addresses to the communications terminals when the packet-in message is received.

The method may include operation 570 of generating a packet-handling rule for forwarding a packet to a physical address by acquiring the physical address of a communications terminal, i.e., the designated receiver, to forward the packet from the ARP table, and transmitting the generated packet-handling rule, and operation 580 of updating the pre-existing packet-handling rule.

To generate the ARP table from each user communications terminal connected to the SDN environment, the relation information between the virtual and physical addresses may be collected from each user communications terminal according to a predetermined period of time set by a user, wherein the ARP table includes the information therebetween.

The method may include generating a packet-handling rule for forwarding a packet to a physical address by acquiring the physical address to forward the packet from the ARP table, transmitting the generated packet-handling rule to be applied to the packet-handling; and updating the pre-existing packet-handling rule.

Here, the update refers to overwriting the pre-existing packet-handling rule and the pre-existing flow entry of the flow table by transmitting the newly generated packet-handling rule. However, examples of the updating method is not limited thereto, and only what changes the pre-existing packet-handling rule to the newly generated packet-handling rule may be used without limit.

Also, the method may include, according to the packet-handling rule, converting the encapsulated ARP request packet to the ARP reply packet that includes the address information of the communications terminal, i.e. the designated receiver, and replying with the ARP reply packet to the communications terminal that has transmitted the ARP request packet.

The method may include handling the packet according to the updated packet-handling rule in 590.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for resolving a physical address based on SDN, the apparatus comprising:
an address matcher configured to receive an address resolution protocol (ARP) request packet, and match a flow entry included in a flow table corresponding to the ARP request packet, wherein the address matcher is configured to in response to the flow entry and the ARP request packet being matched, generate a packet-handling rule and reply with a ARP reply packet, and in response to the flow entry and the ARP request packet being not matched, encapsulate the ARP request packet and transmit the encapsulated ARP request packet; and
a controller configured to update a packet-handling rule by matching information on virtual and physical addresses to information included in an ARP table, wherein the information on virtual and physical addresses is acquired through the received encapsulated ARP request packet and a packet-in message.

2. The apparatus of claim 1, wherein the address matcher further comprises:
a flow table scanner configured to receive the ARP request packet and match the ARP request packet to the flow entry that is included in the flow table; and
a packet-handling rule generator configured to, in response to the matched flow entry being scanned by the flow table scanner, generate the packet-handling rule through the information included in the flow entry, convert the received ARP request packet to the ARP reply packet that includes physical address information of a communications terminal, i.e. a designated receiver, and reply with the ARP reply packet to the ARP request packet; and in response to the matched flow entry being not scanned, encapsulate the received ARP request packet and transmit the encapsulated ARP request packet including the packet-in message to the controller.

3. The apparatus of claim 2, wherein the packet-handling rule generator is configured to in response to a reception of a new packet-handling rule from the controller, update the packet-handling rule, existing in the packet-handling generator, to the newly received packet-handling rule and handle packets.

4. The apparatus of claim 1, wherein the controller further comprises:
a physical address matcher configured to match information on virtual and physical addresses, which are acquired through the received encapsulated ARP request packet and the packet-in message, to the ARP table that includes relation information between the virtual and physical addresses collected from each user communications terminal connected to an SDN environment; and
a packet-handling rule updater configured to acquire a physical address of a communications terminal, i.e., the designated receiver, to forward a packet from the ARP table, generate a packet-handling rule for forwarding the packet to the physical address, transmit the generated packet-handling rule to an address matcher, and update the pre-existing packet-handling rule.

5. The apparatus of claim 4, wherein the packet-handling rule updater is configured to collect the relation information between information on the virtual and physical addresses according to a predetermined period of time set by a user, so as to generate the ARP table that includes the relation information between the virtual and physical addresses from each user communications terminal connected to an SDN environment.

6. The apparatus of claim 4, wherein the packet-handling rule updater is configured to according to the packet-handling rule, convert the encapsulated ARP request packet to the ARP reply packet that includes the address information of the communications terminal, i.e., the designated receiver, and reply with the ARP reply packet to the communications terminal that has transmitted the ARP request packet.

7. A method of resolving a physical address based on SDN, the apparatus comprising:
receiving an address resolution protocol (ARP) request packet, and matching a flow entry included in a flow table corresponding to the ARP request packet, wherein the matching comprises, in response to the flow entry and the ARP request packet being matched, generating a packet-handling rule and reply with a ARP reply packet, and in response to the flow entry and the ARP request packet being not matched, encapsulating the ARP request packet and transmitting the encapsulated ARP request packet; and
updating a packet-handling rule by matching information on virtual and physical addresses to information included in an ARP table, wherein the information on virtual and physical addresses is acquired through the received encapsulated ARP request packet and a packet-in message.

8. The method of claim 7, wherein the encapsulating of the ARP request packet and the transmitting of the encapsulated ARP request packet comprise:
receiving the ARP request packet and matching the ARP request packet to the flow entry that is included in the flow table; and
in response to the matched flow entry being scanned, generating the packet-handling rule through the information included in the flow entry, converting the received ARP request packet to the ARP reply packet that includes physical address information of a communications terminal, i.e. a designated receiver, and replying with the ARP reply packet to the ARP request packet; and in response to the matched flow entry being not scanned, encapsulating the received ARP request packet and transmitting the encapsulated ARP request packet including the packet-in message.

9. The method of claim 8, wherein the transmitting of the encapsulated ARP request packet including the packet-in message comprises:
in response to a reception of a new packet-handling rule, updating the pre-existing packet-handling rule to the newly received packet-handling rule and handling packets.

10. The method of claim 7, wherein the updating of the packet-handling rule comprises:
matching information on virtual and physical addresses, which are acquired through the received encapsulated ARP request packet and the packet-in message, to the ARP table that includes relation information between the virtual and physical addresses collected from each user communications terminal connected to an SDN environment; and
acquiring a physical address of a communications terminal, i.e., the designated receiver, to forward a packet from the ARP table, generating a packet-handling rule for forwarding the packet to the physical address, transmitting the generated packet-handling rule, and updating the pre-existing packet-handling rule.

11. The method of claim 10, wherein the updating of the packet-handling rule comprise:
collecting relation information between information on the virtual and physical addresses according to a predetermined period of time set by a user, so as to generate the ARP table that includes the relation information between the virtual and physical addresses from each user communications terminal connected to an SDN environment.

12. The method of claim 10, wherein the updating of the packet-handling rule comprises:
according to the packet-handling rule, converting the encapsulated ARP request packet to the ARP reply packet that includes the address information of a communications terminal, i.e., the designated receiver, and replying with the ARP reply packet to the communications terminal that has transmitted the ARP request packet.
